(19) United States
(12) Patent Application Publication
(10) Pub. No.: US 2025/0307552 A1
(43) Pub. Date: Oct. 2, 2025

(54) Cross-Modal Adapters for Machine-Learned Sequence Processing Models

(71) Applicant: Google LLC, Mountain View, CA (US)

(72) Inventors: Sayna Ebrahimi, Los Altos Hills, CA (US); Sercan Omer Arik, San Francisco, CA (US); Tejas Nagendra Babu Nama, Mountain View, CA (US); Tomas Jon Pfister, Redwood City, CA (US)

(21) Appl. No.: 19/096,150

(22) Filed: Mar. 31, 2025

Related U.S. Application Data
(60) Provisional application No. 63/571,841, filed on Mar. 29, 2024.

(51) Int. Cl. G06F 40/284; G06F 40/40; G06V 10/774

(52) U.S. Cl. CPC G06F 40/284; G06V 10/774; G06F 40/40

(57) ABSTRACT

A machine-learned system for aligning textual and image representations prior to input to a sequence processing model is described. The system includes a machine-learned image embedding model configured to receive image data and generate one or more image embeddings and a machine-learned text embedding model configured to receive text data and the one or more image embeddings and generate one or more text embeddings. The system includes a machine-learned cross-modal adapter configured to generate one or more text tokens aligned with one or more image tokens based at least in part on aligning data associated with the one or more text embeddings and the one or more image tokens. The system includes a machine-learned sequence processing model configured to generate an output based at least in part on the one or more text tokens and the one more image tokens.

### PRIORITY CLAIM

This application is based upon and claims the right of priority to U.S. Provisional Application No. 63/571,841, filed on Mar. 29, 2024, the disclosure of which is hereby incorporated by reference herein in its entirety for all purposes.

### FIELD

The present disclosure relates generally to machine-learned systems, and more particularly to systems for efficient adaptions of machine-learned multimodal sequence processing models.

### BACKGROUND

Artificial intelligence systems increasingly include large foundational machine-learned models which have the capability to provide a wide range of new product experiences. For example, multimodal sequence processing models demonstrate remarkable image-language capabilities. However, the widespread use of such models faces numerous challenges, particularly as the models are adapted for different downstream uses in different domains. For example, existing approaches often necessitate expensive retraining of the foundational model and provide little adaptability.

### SUMMARY

Aspects and advantages of embodiments of the present disclosure will be set forth in part in the following description, or can be learned from the description, or can be learned through practice of the embodiments.

One example aspect of the present disclosure is directed to a system including one or more processors and one or more non-transitory computer-readable media that collectively store a machine-learned system a machine-learned image embedding model configured to receive image data and generate one or more image embeddings, a machine-learned text embedding model configured to receive text data and the one or more image embeddings and generate one or more text embeddings, a machine-learned cross-modal adapter configured to generate one or more text tokens aligned with one or more image tokens based at least in part on aligning data associated with the one or more text embeddings and the one or more image embeddings, and a machine-learned sequence processing model configured to receive the one or more text tokens and the one more image tokens and generate an output based at least in part on the one or more text tokens and the one more image tokens.

Another example aspect of the present disclosure is directed to a computer-implemented method that includes, by a computing system comprising one or more computing devices, providing input text to a text embedding model and input imagery to an image embedding model, generating, using a machine-learned image embedding model, image embeddings based at least in part on the input imagery, generating, using a machine-learned text embedding model, text embeddings based at least in part on the input text and the image embeddings, generating, using a machine-learned cross-modal adapter, one or more text tokens and one or more image tokens based at least in part on the text embeddings and the image embeddings, and providing, an input to a machine-learned sequence processing model. The input includes a tokenization of the input text, the one or more text tokens, and the one or more image tokens. The method includes generating, using the machine-learned sequence processing model, an output based at least in part on the tokenization of the input text, the one or more text tokens and the one or image tokens.

Yet another example aspect of the present disclosure is directed to a computer-implemented method that includes obtaining, by a computing system comprising one or more computing devices, data describing a machine-learned system including a machine-learned text embedding model, a machine-learned image encoding model, a machine-learned cross-modal adapter, and a machine-learned sequence processing model. The method includes obtaining, by the computing system, a first set of training data including image-caption pairs and training, by the computing system using the first set of training data, the machine-learned system during a first training stage in which the machine-learned cross-modal adapter is trained while parameters of the machine-learned text embedding model, the machine-learned image embedding model, and the machine-learned sequence processing model are frozen. The method includes obtaining, by the computing system, a second set of training data including image-instruction pairs and training, by the computing system using the second set of training data, the machine-learned system during a second stage in which the machine-learned cross-modal adapter and the machine-learned text embedding model are trained while parameters of the machine-learned image embedding model and the machine-learned sequence processing model are frozen.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram of an example computing environment including a machine-learned system having a machine-learned cross-modal adapter for pre-aligning visual and textual representations for a machine-learned sequence processing model according to example implementations of the present disclosure;

FIG. 2 is a block diagram of an example computing environment including a machine-learned system having a machine-learned cross-modal adapter for pre-aligning visual and textual representations for a machine-learned sequence processing model according to example implementations of the present disclosure;

FIG. 3 is a block diagram of an example computing environment depicting training of a machine-learned system having a machine-learned cross-modal adapter according to example implementations of the present disclosure;

FIG. 4 is a block diagram of an example computing environment a machine-learned cross-modal adapter according to example implementations of the present disclosure;

FIGS. 5A-5C are block diagrams of an example computing environment depicting multiple training stages of a machine-learned system having a machine-learned cross-modal adapter according to example implementations of the present disclosure;

FIG. 6 is a flow chart diagram illustrating an example method for training a machine-learned system including a cross-modal adapter according to example implementations of the present disclosure;

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example implementations of aspects of the present disclosure;

FIG. 9 is a block diagram of an example sequence processing model according to example implementations of aspects of the present disclosure;

FIG. 10 is a block diagram of an example technique for populating an example input sequence for processing by a sequence processing model according to example implementations of aspects of the present disclosure;

FIG. 11 is a block diagram of an example model development platform according to example implementations of aspects of the present disclosure;

FIG. 12 is a block diagram of an example training workflow for training a machine-learned model according to example implementations of aspects of the present disclosure;

FIG. 13 is a block diagram of an inference system for operating one or more machine-learned model(s) to perform inference according to example implementations of aspects of the present disclosure;

FIG. 14 depicts a block diagram of an example networked computing system that can perform aspects of example implementations of the present disclosure;

FIG. 15 is a block diagram of an example computing device according to example implementations of aspects of the present disclosure; and

FIG. 16 is a block diagram of an example computing device according to example implementations of aspects of the present disclosure.

Reference numerals that are repeated across plural figures are intended to identify the same features in various implementations.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, the present disclosure is directed to machine-learned systems that include an efficient framework to adapt multimodal sequence processing models such as multimodal large language models (LLMs) for image-language applications. In accordance with example embodiments of the present disclosure, a cross-modal adapter is provided that effectively combines visual and textual representations prior to input to a pre-trained multimodal sequence processing model. The cross-modal adapter can be trained with minimal parameters and can enable efficient cross-modal understanding of image and language representations for image-language applications such as visual question answering in which a model provides a textual response to a question about imagery and instruction-following in which a model performs a task based on imagery and a textual instruction. The cross-modal adapter enables alignment of text and image data prior to input to a sequence processing model, demonstrating an ability for scalable, adaptable, and parameter-efficient multimodal models.

Recent advancements in multimodal sequence processing models such as multimodal large language models have yielded impressive breakthroughs across many scenarios particularly in image language learning for tasks such as image captioning and visual question answering. Often, the systems are built using instruction guidance to improve the multimodal capabilities of a large language model. In many instances, the success of these models has been shown to depend on large-scale training data which can include hundreds of millions to over a billion instances of training data, often yielding high training costs. Efficient frameworks and methods for building large image-language models from image-only or text-only pre-trained models, as well as tuning them for target multimodal use cases are everlasting challenges.

One key challenge that can lead to high computational costs is extensive parameter counts involved in training image encoders and language models. Additionally, while retraining LLM's with multimodal data helps align visual and textual tokens, it can come at the risk of undermining a pre-trained LLM's reasoning capabilities. Furthermore, as the variety of LLMs continues to grow, a retraining approach hinders the potential for plug-and-play integration within multimodal frameworks. Many models rely on simplistic linear projections before token concatenation. Nevertheless, even where a query transformer is used, pretraining remains computationally expensive and fine-tuning for specific domains can be parameter inefficient. Additionally, while zero shot performance results have shown potential to handle diverse tasks without training data, there is a significant opportunity to maximize effectiveness in cases where data for specific downstream tasks is available.

In accordance with example embodiments of the present disclosure, an image language framework is provided for unifying image and language representations prior to input to sequence processing models such as multimodal large language models. The disclosed technology can promote superior cross-modal understanding while maintaining parameter efficiency. Visual (also referred to as image) and textual representations can be pre-aligned before input to a multimodal sequence processing model, offering a more flexible, efficient, and scalable strategy for adapting machine learned systems for downstream tasks. According to an example aspect, a cross-modal adapter is provided that can effectively align or otherwise fuse multimodal data and provide cross-modal learning.

An image language framework in accordance with example aspects of the present disclosure can include an image embedding model (e.g., a vision encoder), a text embedding model (e.g., a query transformer), and a cross-modal adapter. The cross-modal adapter can be gated and used for aligning image and textual tokens before input to a sequence processing model to enable multimodal learning. This approach can avoid costly training of the sequence processing model while maintaining generalization of text understanding and reasoning tasks. An effective, cost-effective and flexible fine-tuning strategy is provided to maximize multimodal sequence processing model effectiveness with availability of data from specific downstream tasks. The multimodal adapter design enables both cross-modal understanding and parameter efficient fine-tuning, as only the adapter is trained during adaptation in example embodiments. For example, the cross-modal adapter can work with encoder-decoder and decoder-only sequence processing models. During large-scale instruction tuning, the cross-modal adapter and the text embedding model can be trained while parameters of the sequence processing model and the imaging embedding model are frozen. For subsequent supervised fine-tuning on smaller data sets for a particular domain or task, the cross-modal adapter can be the sole trainable component while parameters of the text embedding model, the image embedding model, and the sequence processing model are all frozen.

According to an example aspect of the present disclosure, a machine learned system is provided that includes a multimodal sequencing processing model framework configured to receive an image input and a text input as a multimodal input, and generate a text output. In example embodiments, the text can be generated in an autoregressive manner. A machine learned system in accordance with example embodiments of the present disclosure can include a pre-trained sequence processing model such as a pre-trained large language model (LLM), an image embedding model, a text embedding model, and a cross-modal adapter model. The cross-modal adapter model can receive projected image embeddings and textual embeddings and generate an aligned image output and text output.

An image input can be provided to an image embedding model such as a vision encoder to extract image features before processing by one or more linear projection layers and a text embedding model. During pretraining and instruction tuning, parameters of the image embedding model can be frozen to maintain its pre-trained visual representations in order to obtain a low-cost and parameter efficient training. The associated projection layer can be trained during these stages. During optional task-specific fine-tuning, parameters of the image embedding model and its associated projection layer(s) can be frozen.

A text input can be provided to a text embedding model such as a query transformer (Q-Former). Additionally, the image embeddings generated by the image embedding model can be provided to the text embedding model. The text embedding model can provide for the interaction of queries with each other through one or more self-attention layers and with frozen image features through one or more cross-attention layers. The cross-attention layers can be inserted after every other transformer block. The text embedding model can extract textual features which are then processed by a text projection layer. During pretraining, parameters of the text embedding model can be frozen to maintain its pre-trained text representations. The associated projection layer can be trained during pre-training. During instruction tuning, the text embedding model can be trained along with its associated projection layer. During optional task-specific fine-tuning, parameters of the text embedding model and its associated projection layer can be frozen.

According to an example aspect of the present disclosure, the machine learned cross-modal adapter is configured to align text embeddings and image embeddings to generate text tokens that are aligned with image tokens for input to the sequence processing model. Unlike typical adapter placements after feedforward and self-attention layers in transformers, the cross-modal adapter facilitates the fusion of textual and visual representations before they are provided as input to the sequence processing model. This pre-LLM fusion enables alignment of different modalities for optimal understanding within the large language model. In example embodiments, the cross-modal adapter is trained during pretraining, instruction tuning, and optional task specific fine-tuning. In some examples during fine-tuning, the cross-modal adapter is the only trainable component, enabling efficient adaptation of the cross-modal adapter and allowing it to adapt to new tasks without extensive retraining of the core sequence processing model.

According to an example aspect of the present disclosure, the cross-modal adapter can include a bottleneck structure including a down projection unit, an up-projection unit, and skip connections. This design can enable efficient processing of high dimensional input features. Modality specific down sampling units can be used for division and text branches of the cross-modal adapter, wherein in each, an input d-dimensional feature vector is projected to a smaller dimension, m. The down projection unit can include a text down sampling unit that is configured to project text features to the smaller dimension and an image down sampling unit configured to project image features to the smaller dimension. The down projection unit can include a gated linear unit in example embodiments. The down projection unit can compute the component-wise product of two linear transformations. The input to one of the linear transformations can be sigmoid activated. This gating mechanism can help the adapter control the flow of information, potentially emphasizing the most useful and relevant multimodal relationships. For each down-projection unit, given an input text or image feature embedding of a particular size, the output can be mapped using a sigmoid linear unit function (SiLU).

The up-projection unit can use a weight sharing mechanism between the two modalities where the m-dimensional vector is projected back to the input dimensions, in order to better encourage learning of cross-modal relations. In an example embodiment, the up-projection unit can include a weight sharing linear layer. According to an example aspect, the up-projection unit can include a text up-sampling unit and an image up-sampling unit that share the one or more weights. The up-projection unit can be configured to project the text features from the smaller dimension to an input dimension and the image features from the smaller dimension to the input dimension.

The input to the sequence processing model can be formed by concatenating the input text, the output of the text branch of the cross-modal adapter, and the output of the image branch of the cross-modal adapter. The input text can be tokenized for combination with the output of the text branch and the output of the image branch. The input can include a concatenation of the one or more text tokens generated by the cross-modal adapter, the one or more image tokens generated by the cross-modal adapter, and the one or more tokens generated from the input text.

According to an example aspect of the disclosed technology, a machine learned system for adaptation of sequence processing models can be trained in multiple stages. By way of example, a first training stage or process can include pretraining with image caption pairs. A second training stage or process can include instruction tuning with image instructions on a variety of tasks. A third training stage or process can include optional task specific efficient fine-tuning. This third training stage can be used if data is available for a specific target task to optimize the cross-modal adapter's task specific performance. In example embodiments, next token prediction can be used as a training objective where the sequence processing model predicts the next word conditioned on previous multimodal visual and text tokens. This can encourage the model to accurately generate subsequent tokens based on the context of preceding tokens. The machine learned system can be trained end-to-end in example embodiments.

In a first training stage or process, pretraining of the machine learned system can be performed. The pretraining phase can be designed to align modalities within the projection layers. In an example embodiment, the image and text projection layers can be trained alongside the cross-modal adapter during pretraining. The remaining model layers can be kept frozen. For example, parameters of the text embedding model, the image embedding model, and the sequence processing model can be frozen (i.e., not subject to modification) during pretraining.

In a second training stage or process, instruction tuning of the machine learned system can be performed. Instruction tuning can be performed to refine the model to follow instructions accurately. A diverse set of image instruction pairs can be used to train the model to answer specific queries about images, extending the model's abilities beyond the image captioning learned during pretraining. Learnable queries can be used as input during instruction tuning. During instruction tuning, the text embedding model, the cross-modal adapter, and the image and text projection layers can be trained. The remaining model layers can be kept frozen. For example, parameters of the image embedding model and the sequence processing model can be frozen during instruction tuning. This training technique enables the model to efficiently learn instruction aware queries, facilitated by the cross-modal interaction between image embeddings and queries within the text embedding model. The result of instruction tuning is a model capable of strong zero-shot performance on visual questioning answering benchmarks.

In an optional third training stage or process, optional task specific fine-tuning can be performed. When additional test specific data (often smaller scale than the previous stages) is available, this third training stage can further optimize the cross-modal adapter's performance at a target task. The cross-modal adapter can allow for efficient fine-tuning by limiting the number of trainable parameters. For example, the number of trainable parameters in an example embodiment is approximately 5 million. In addition to low cost task specific tuning, such parameter efficiency yields constitute an effective mechanism to prevent over fitting, a commonly observed challenge with small amounts of test specific data.

Systems and methods in accordance with example embodiments of the present disclosure provide a number of technical effects and benefits. Existing approaches for training and adapting multimodal sequence processing models such as multimodal LLMs often rely on expensive language model retraining and limited adaptability. For example, hundreds of millions to billions of training samples (image-text pairs) may be required and 100 graphical processing unit (GPU) hours required to process the samples. Retraining an already trained LLM can require a large amount of data, computing resources, and time. Additionally, many existing approaches focus on zero-shot performance which can provide insufficient guidance for task-specific tuning of models. In accordance with example embodiments of the present disclosure, a machine-learned system is provided that includes a cross-modal adapter that facilitates an efficient image-language instruction tuning framework. A cross-modal adapter effectively combines visual and textual representations prior to input to a pre-trained sequence processing model. The cross-modal adapter is lightweight and can be trained with minimal parameters to enable efficient cross-modal understanding. Fine-tuning can be performed with exceptional parameter efficiency. The cross-modal adapter demonstrates the ability of pre-model alignment of image and textual data for building scalable, adaptable, and parameter-efficient multimodal models.

In accordance with example embodiments of the present disclosure, a cross-modal adapter enables reduced parameter counts for training the system for multimodal tasks. Additionally, visual and textual tokens can be pre-aligned before input to the sequence processing model. This approach provides more efficient uses of computing resources and time, and reduces the amount of training data that may be required. Further this approach avoids the risk of undermining a pretrained sequence processing model's reasoning capabilities. Furthermore, this approach provides a more flexible, efficient, and scalable system.

In example implementations, a machine-learned system may include one or more sequence processing models in communication with a cross-modal adapter. A sequence processing model may be referred to as a generative model. A sequence processing model can include a large language model (LLM). The sequence processing model may be trained to respond to input data and provide a generative output such as a text prediction based on an image input and a text input. Alternatively and/or additionally, the generative model can include an image generation model (e.g., a text-to-image diffusion model). The generative model can be trained to process text data to generate image data. The image data can be descriptive of the subject and/or details associated with the text data. The image data can depict a new image that differs from the training data. In some implementations, the generative model can process multimodal data to generate the image data, which can include image data, text data, content data, audio data, and/or latent encoding data.

In some implementations, the systems and methods can obtain input data from a user computing system. The input data can include one or more text strings and/or imagery such as image data representing one or more images. The input data can be processed with the sequence processing model to generate one or more outputs. The one or more outputs can then be provided to the user computing system. The input data may include text data, image data, audio data, latent encoding data, and/or multimodal data. The output data may include text data, image data, audio data, latent encoding data, and/or multimodal data.

Alternatively and/or additionally, the systems and methods can obtain input data. The input data can include one or more text strings and/or image data. The input data can be processed to determine a particular task associated with input data. The particular task can be associated with a creation task (e.g., writing a poem and/or generating a painting style image), a knowledge task (e.g., responding to a knowledge query with factual information), and/or a conversational task (e.g., responding to user messages that are associated with a mix of user experiences, emotions, and/or facts).

Much of the following disclosure refers to large language models as specific examples of sequence processing models but it will be appreciated that the disclosure is equally applicable to any type of sequence processing model. For example, the disclosed technology can be used with large image models, multimodal models, and other types of foundational models. For instance, the generative models can operate in domains other than the text domain, such as image domains, audio domains, biochemical domains, etc. For instance, a sequence processing model may be used to process sequential inputs for robotic controls and other tasks. Similarly, the generative model and/or the downstream applications can be configured to perform any number of tasks. For instance, if the inputs to the generative model and/or a downstream application are images or features that have been extracted from images, the output generated by the generative model for a given image can be scores for each of a set of object categories, with each score representing an estimated likelihood that the image contains an image of an object belonging to the category. As another example, if the inputs to the generative model and/or a downstream application are sensor data, the outputs can be robotic control signals. The system can analyze the distance of generated signals relative to a target domain (e.g., using intended signals) to determine the validity of the generated signals.

As another example, if the input to the sequence processing model is a sequence representing a spoken utterance, the output generated can be a score for each of a set of pieces of text, each score representing an estimated likelihood that the piece of text is the correct transcript for the utterance.

As another example, if the input to the sequence processing model is a sequence of physiological measurements, the output generated may be a score for each of a set of possible diagnoses for the condition of a user, with the score representing an estimated likelihood that the diagnosis is accurate. In example embodiments, the controller can assess whether the physiological measurements are relevant to a particular domain (e.g., a diagnosis). In such a case, the system could detect whether the physiological measurements match a particular diagnosis associated with the measurements.

As another example, if the input to the sequence processing model is a sequence of text from a received communication, the output generated may be a score for each of a set of possible responses to the received communication, with the score representing an estimated likelihood that the response matches a user's intent.

As another example, if the input to the sequence processing model is indicative of a particular function to be performed by an apparatus (such as a robot), the output generated may be a score for each of a set of possible control signals for controlling the apparatus, with the score representing an estimated likelihood that the control signals match the particular function to be performed.

As another example, if the input to the sequence processing model includes natural language indicative of a computer implemented operation, the output generated may be a score for each of a set of possible computer-readable code segments, with the score representing an estimated likelihood that the computer-readable code segments match the computer implemented operation.

As another example, if the input to the sequence processing model is a sequence of text in one language, the output generated may be a score for each of a set of pieces of text in another language, with each score representing an estimated likelihood that the piece of text in the other language is a proper translation of the input text into the other language.

Although a number of examples of tasks which may be performed by the sequence processing model and/or a downstream application are provided here, it will be understood that this is not exhaustive, and that the generative model and/or the downstream applications can be configured to perform any suitable task.

With reference now to the Figures, example embodiments of the present disclosure will be discussed in further detail.

### Example Model Arrangements

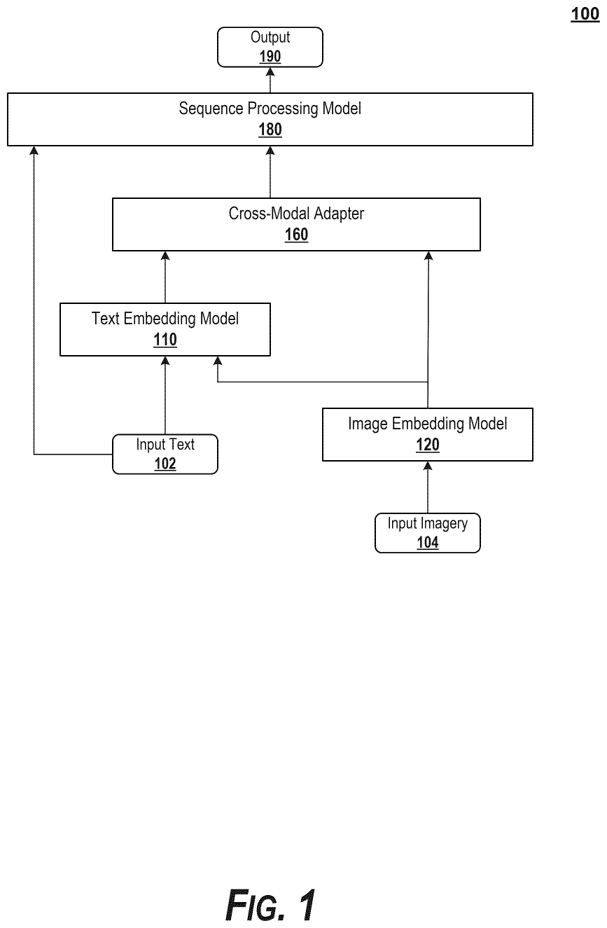

FIG. 1 is a block diagram of an example computing environment 100 including a machine-learned system having a machine-learned cross-modal adapter for pre-aligning visual and textual representations for a machine-learned sequence processing model according to example implementations of the present disclosure. The machine-learned system includes an image embedding model 120 configured to receive input imagery 104 and generate one or more image embeddings. The image embedding model can include a vision encoder configured to extract image features and generate the image embeddings. Input imagery 104 can include data representative of one or more images, videos, or other visual data. The machine-learned system includes a text embedding model 110 configured to receive input text 102 and generate one or more text embeddings. Input text 102 can include data representative of one or more instructions, queries, or other textual data. The text embedding model 110 can also receive the one or more image embeddings as input. The text embedding model can include a query transformer (Q-Former) having an architecture in which the textual inputs (e.g., queries) interact with each other through one or more self-attention layers and with frozen image features through one or more cross-attention layers which can be inserted after every other transformer block.

The text embeddings from the text embedding model and the image embeddings from the image embedding model are provided as inputs to cross-modal adapter 160. In example implementations, before the cross-modal adapter, the text embeddings can first be provided to one or more text projection layers and the image embeddings can be provided to one or more image projection layers. The cross-modal adapter 120 can include a lightweight machine-learned cross-modal module that is placed before sequence processing model 180. The cross-modal adapter facilitates the fusion of textual and visual representations before they enter the sequence processing model 180. This pre-model fusion provides for aligning different modalities (e.g, text modalities and image modalities) for optimal understanding within the sequence processing model 130. Sequence processing model 180 generates one or more outputs 190 which may include text, images, and/or other data.

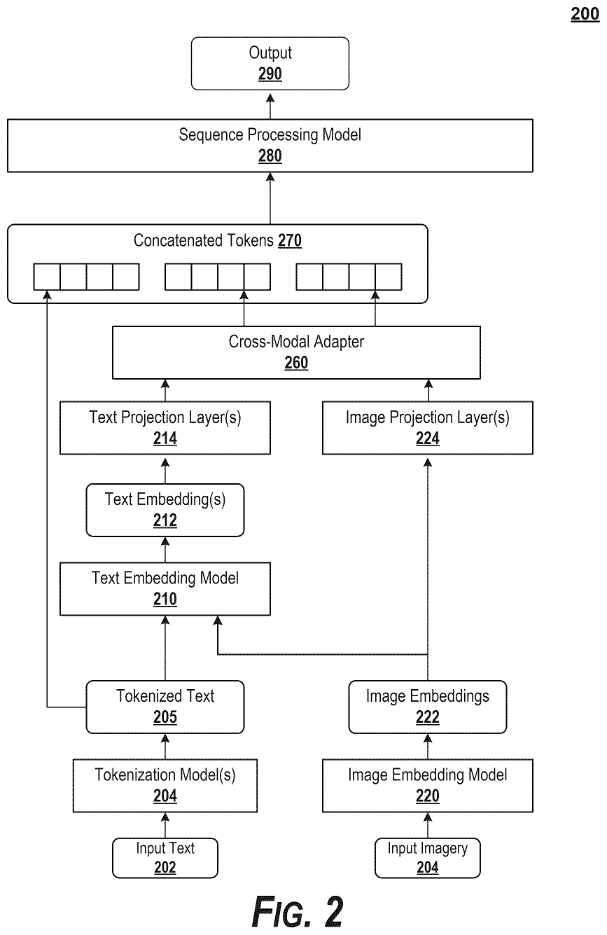

FIG. 2 is a block diagram of an example computing environment 200 including a machine-learned system having a machine-learned cross-modal adapter for pre-aligning visual and textual representations for a machine-learned sequence processing model according to example implementations of the present disclosure. The machine-learned system includes an image embedding model 220 configured to receive input imagery 204 and generate one or more image embeddings 222. The image embedding model 220 is one example of image embedding model 120. The input text 202 is provided to one or more text tokenization models (e.g., BERT) configured to generate tokenized text which can include one or more input text tokens. Text embedding model 210 is configured to receive the tokenized text 205 and generate one or more text embeddings 212. The text embedding model 210 is configured to also receive the one or more image embeddings 222 as input. The text embedding model 210 is one example of text embedding model 110.

The text embeddings 214 from the text embedding model 210 are provided to one or more text projection layers 214 and the image embeddings 222 from the image embedding model are provided as inputs to one or more image projection layers 224. The projected text embeddings and the projected image embeddings are provided as inputs to the cross-modal adapter 240. The cross-modal adapter can align or otherwise fuse the textual and visual projections before they enter the sequence processing model 280. In FIG. 2, the projected text embeddings and the projected image embeddings are processed through image and text branches to generate a set of image tokens and a set of text tokens. The set of image tokens and the set of text tokens can be concatenated along with the tokenized text 205 to form concatenated tokens 270 that are provided as an input to the sequence processing model. The sequence processing 280 model can generate one or more outputs include a text output based on the input text and the input image.

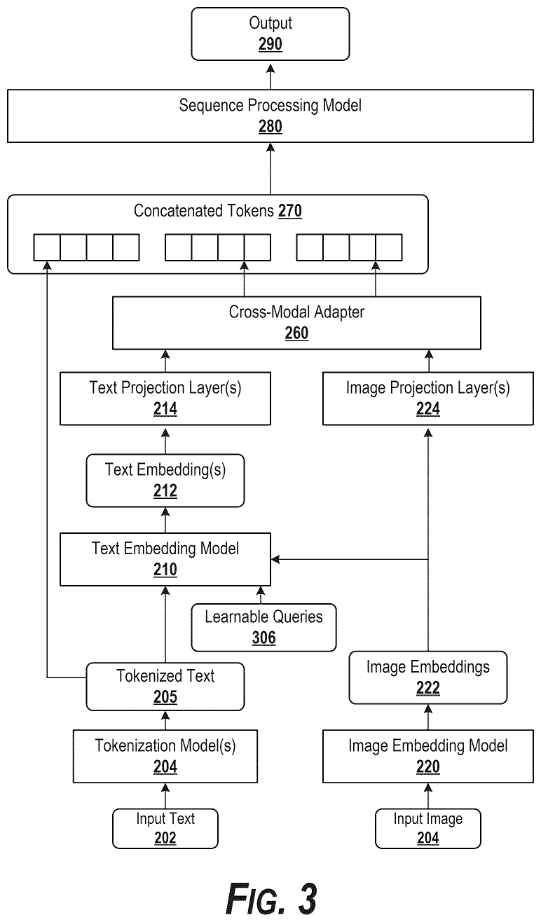

FIG. 3 is a block diagram of an example computing environment 300 depicting training of a machine-learned system having a machine-learned cross-modal adapter 260 as described in FIG. 2. A set of learnable queries 306 is provided to the text embedding model 210 during training. For example, a query transformer of the text embedding model can utilize the learnable queries 306 to effectively represent instruction-aware visual features. The instruction-aware visual features are then processed by the text projection layers(s) 214.

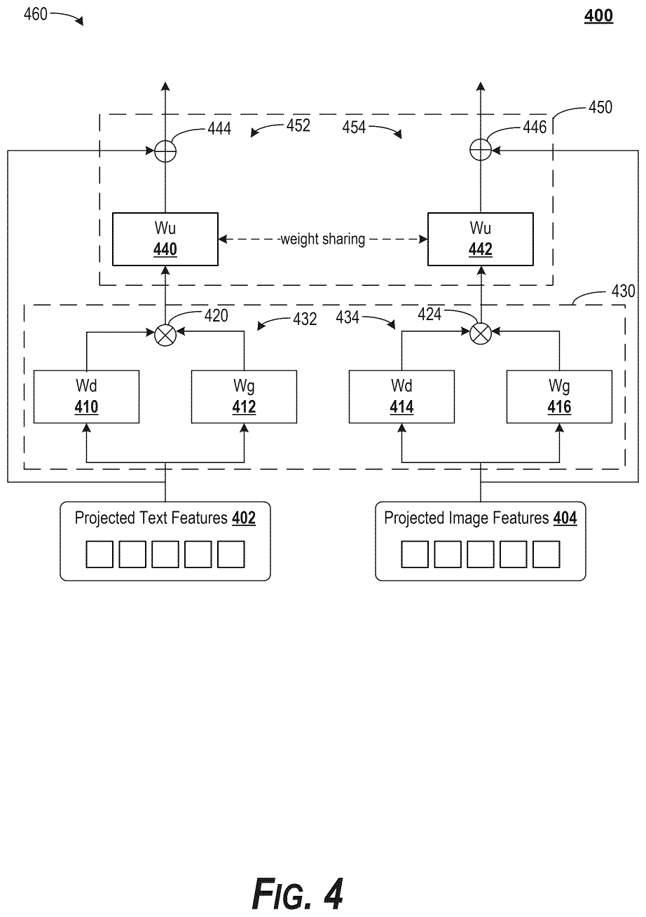

FIG. 4 is a block diagram of an example computing environment 400 including a machine-learned cross-modal adapter 460 according to example implementations of the present disclosure. Cross-modal adapter 460 is one example of cross-modal adapter 160 and cross-modal adapter 260. Cross-modal adapter 460 has a bottleneck structure including one or more down-projection units 430 and one or more up-projection units 450. Down-projection unit 430 includes modality specific down-sampling units for the image and text branches of the cross-modal adapter. Text down-sampling unit 432 receives an input d-dimensional feature vector and projects it to a smaller dimension, m. Image down-sampling unit 434 receives an input d-dimensional feature vector and projectors it to the smaller dimension, m. The down-projection units can include gated linear units. Projected text features 402 and projected image features 404 are input to the cross-modal adapter 460. The text down-projection unit includes two linear transformations W_{d} 410 and W_{g} 412 and the image down-projection unit includes two linear transformations W_{d} 414 and W_{g} 416. The text down-projection unit includes a multiplier 420 configured to compute the component-wise product of the linear transformations W_{d} 410 and W_{g} 412. The image down-projection unit includes a multiplier 424 configured to compute the component-wise product of the linear transformations W_{d} 414 and W_{g} 416. In one example, the input to one of W_{d} or W_{g} can be sigmoid activated. This gating mechanism enables the adapter to control the flow of information, potentially emphasizing the most useful and relevant multimodal relationships.

In an example implementation, linear transformation W_{d} can be defined as W_{d} ∈ [symbol] ^{d×m} and linear transformation W_{g} can be defined as W_{g} ∈ [symbol] ^{d×m}. For each down-projection unit, given an input text or image feature embedding of size x∈ [symbol] ^{d}, the output can be mapped as: z(x)=SiLU(xW_{d}⊗xW_{g}. SiLU is a Sigmoid Linear Unit function.

Up-projection unit 450 includes a text up-sampling unit 452 and an image up-sampling unit 454. Text up-sampling unit includes a linear transformation Wᵤ 440 and a multiplier 444. Text up-sampling unit 454 includes a linear transformation Wᵤ 442. The up-projection unit 450 uses a weight-sharing mechanism between the two modalities where the m-dimensional vector z∈ [symbol] ^{m} is projected back to d input dimensions via W∈ [symbol] ^{m×d}. This can encourage better learning of cross-modal relations. Overall the input of each branch of the cross-modal adapter 460 can be formulated as: Cross-Modal Adapter (x, W_{d}, W_{g}, Wᵤₚ)=x+zWᵤ. The output of the text branch and the output of the image branch of the cross-modal adapter 460 can be concatenated with the tokenized input text.

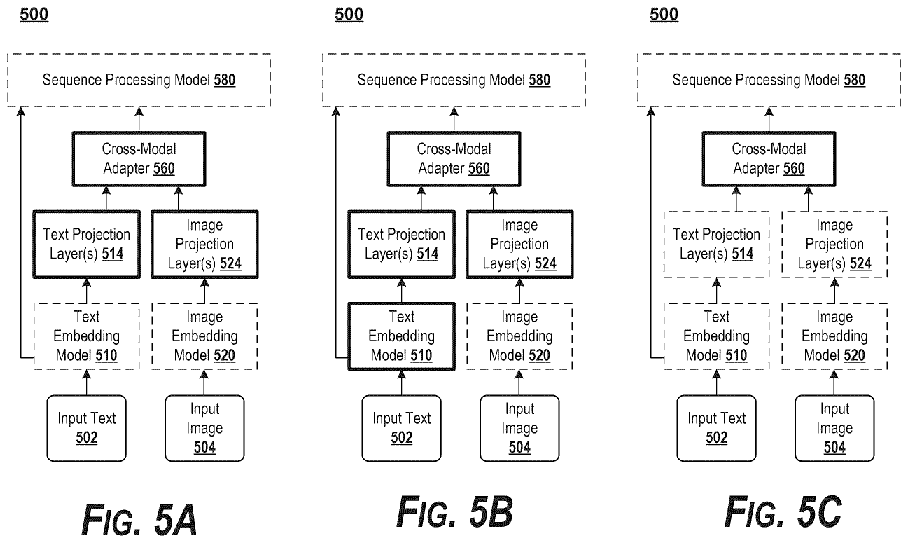

FIGS. 5A-5C are block diagrams of an example computing environment depicting multiple training stages of a machine-learned system having a machine-learned cross-modal adapter according to example implementations of the present disclosure. FIG. 5A depicts a first training stage or process. The first training stage can include pretraining of the machine learned system using image-caption pairs. Input text 502 (e.g., image caption) can be provided to the text embedding model 510 and input imagery 504 can be provided to the image embedding model. The pretraining phase can be designed to align modalities within the projection layers. In an example embodiment, the image projection layers 524 and text projection layers 514 can be trained alongside the cross-modal adapter 560 during pretraining. The remaining model layers can be kept frozen. For example, parameters of the text embedding model 510, the image embedding model 520, and the sequence processing model 580 can be frozen (i.e., not subject to modification) during pretraining.

FIG. 5B depicts a second training stage or process. The second training stage can include instruction tuning with large-scale image-instructions. Input text 502 (e.g., instructions) can be provided to the text embedding model 510 and input imagery 504 (e.g., input image) can be provided to the image embedding model. Instruction tuning can be performed to refine the model to follow instructions accurately. A diverse set of image instruction pairs can be used to train the model to answer specific queries about images, extending the model's abilities beyond the image captioning learned during pretraining. Learnable queries can be used as input during instruction tuning. During instruction tuning, the text embedding model 510, the cross-modal adapter 560, and the image projection layers 524 and text projection layers 514 can be trained. The remaining model layers can be kept frozen. For example, parameters of the image embedding model 520 and the sequence processing model 580 can be frozen during instruction tuning. This training technique enables the model to efficiently learn instruction aware queries, facilitated by the cross-modal interaction between image embeddings and queries within the text embedding model. The result of instruction tuning is a model capable of strong zero-shot performance on visual questioning answering benchmarks.

FIG. 5C depicts an optional third training stage or process which can include optional task specific fine-tuning. Input text 502 (e.g., task-specific instruction) can be provided to the text embedding model 510 and input imagery 504 can be provided to the image embedding model. During task-specific fine-tuning, the cross-modal adapter 560 can be trained. The remaining model layers can be kept frozen. For example, parameters of the image embedding model 520, the text embedding model 510, the image projection layers 524, text projection layers 514, and the sequence processing model 580 can be frozen during fine-tuning. When additional test specific data (often smaller scale than the previous stages) is available, this third training stage can further optimize the cross-modal adapter's performance at a target task. The cross-modal adapter can allow for efficient fine-tuning by limiting the number of trainable parameters. For example, the number of trainable parameters in an example embodiment is approximately 5 million. In addition to low cost task specific tuning, such parameter efficiency yields constitute an effective mechanism to prevent over fitting, a commonly observed challenge with small amounts of task specific data.

### Example Methods

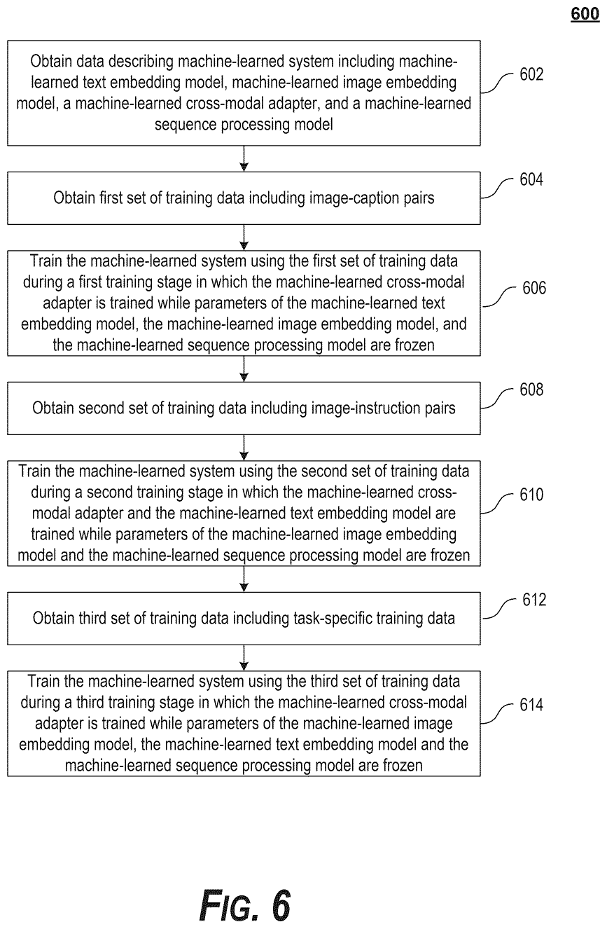

FIG. 6 is a flowchart depicting a method 600 for training a machine-learned system including a cross-modal adapter for aligning visual and textual representations prior to input to a sequence processing model. One or more portion(s) of example method 600 and the other methods described here can be implemented by a computing system that includes one or more computing devices such as, for example, a machine-learned computing system as described herein. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, method 600 can include obtaining data describing machine-learned system including a machine-learned text embedding model, a machine-learned image embedding model, a machine-learned cross-modal adapter, and a machine-learned sequence processing model.

At 604, method 600 can include obtaining a first set of training data (e.g., image-caption pairs).

At 606, method 600 can include training the machine-learned system using the first set of training data during a first training stage. During the first training stage, training the machine-learned system can include training the machine-learned cross-modal adapter while parameters of the machine-learned text embedding model, the machine-learned image embedding model, and the machine-learned sequence processing model are frozen. In an example implementation at 606, method 600 can include training one or more text projection layers and one or more image projection layers.

At 606, method 600 can include obtaining a second set of training data (e.g., image-instruction pairs).

At 608, method 600 can include training the machine-learned system using the second set of training data during a second training stage. During the second training stage, training the machine-learned system can include training the machine-learned cross-modal adapter and the machine-learned text embedding model while parameters of the machine-learned image embedding model and the machine-learned sequence processing model are frozen. In an example implementation at 608, method 600 can include training one or more text projection layers and one or more image projection layers.

At 610, method 600 can include obtaining a third set of training data (e.g., task-specific training data). The operation(s) at 610 is optional.

At 612, method 600 can include training the machine-learned system using the third set of training data during a third training stage. The operation(s) at 612 is optional. During the third training stage, training the machine-learned system can include training the machine-learned cross-modal adapter is trained while parameters of the machine-learned image embedding model, the machine-learned text embedding model and the machine-learned sequence processing model are frozen. In an example implementation at 612, method 600 can include training while parameters of one or more text projection layers and one or more image projection layers are frozen.

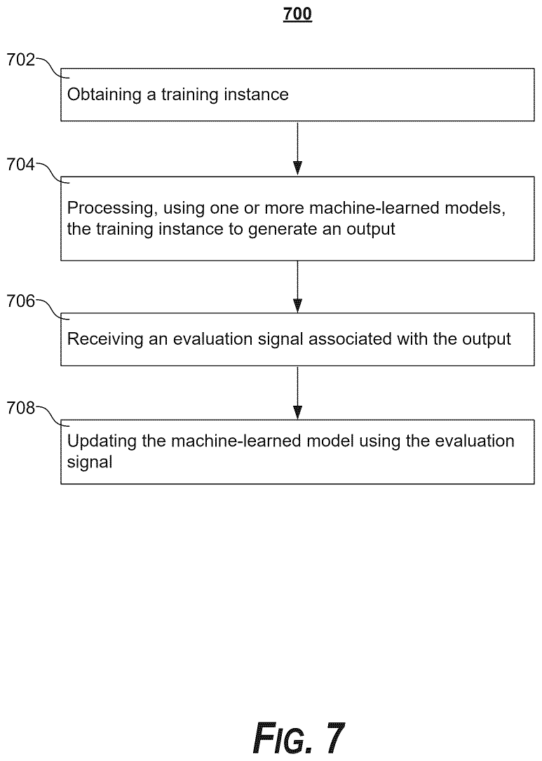

FIG. 7 depicts a flowchart of a method 700 for training one or more machine-learned models according to aspects of the present disclosure. For instance, an example machine-learned model can include a cross-modal adapter, text embedding model, image embedding model, text projection model, or image projection model. The example method can be used to train a machine-learned system including multiple machine-learned models or layers. The example method can be used for end-to-end training in which training data is processed through multiple models to determine an output.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

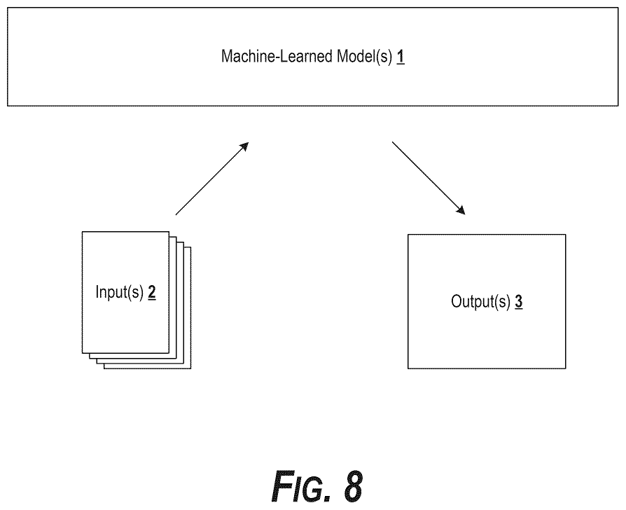

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

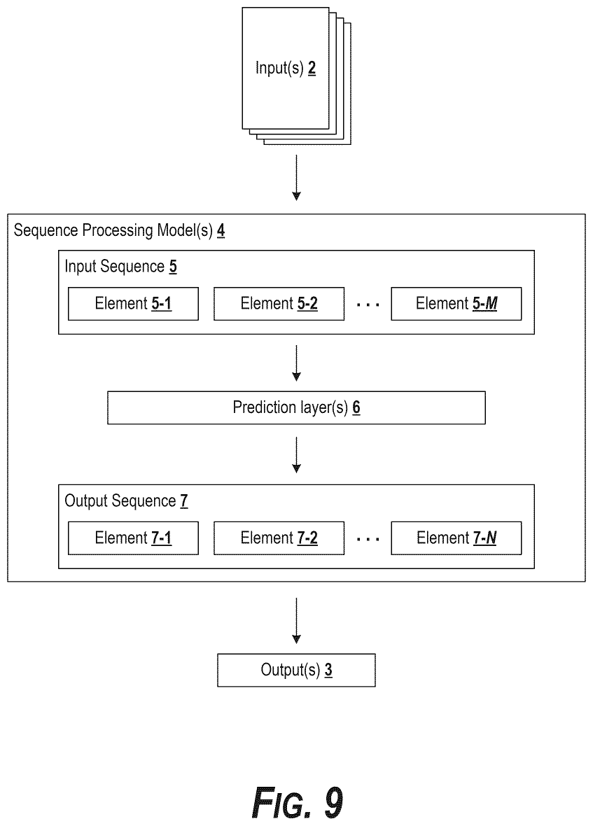

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

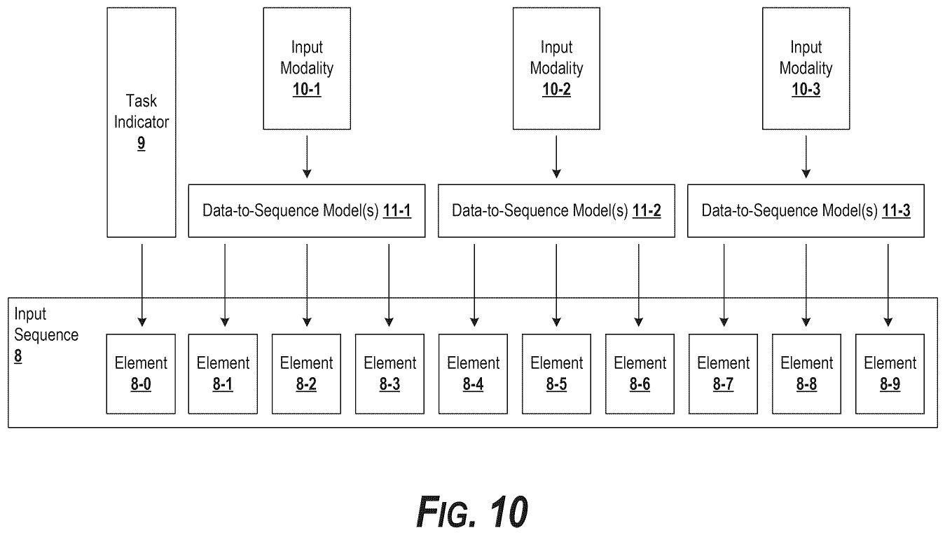

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

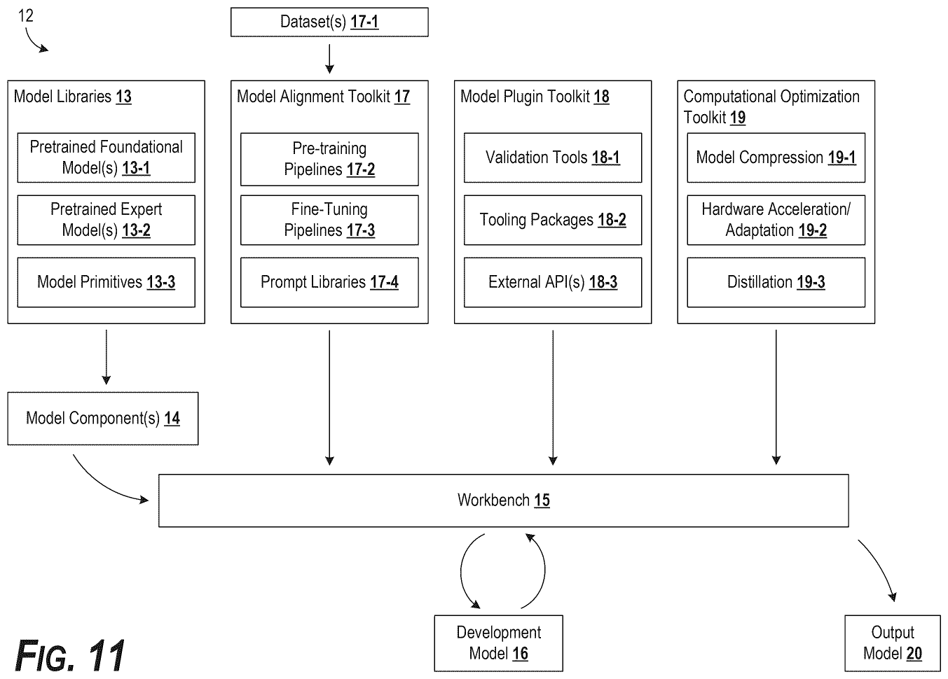

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

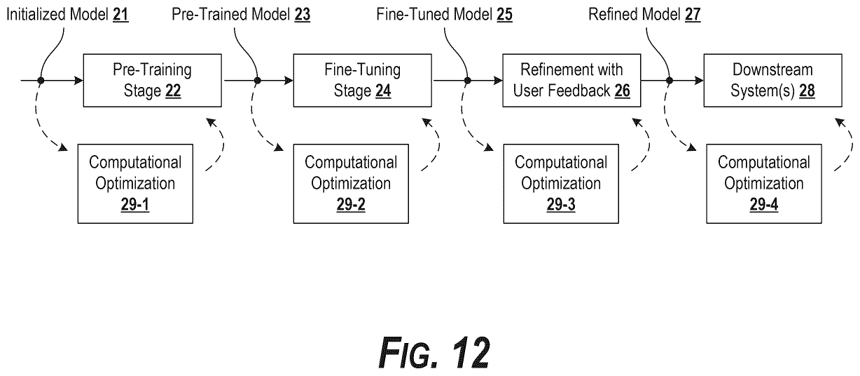

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

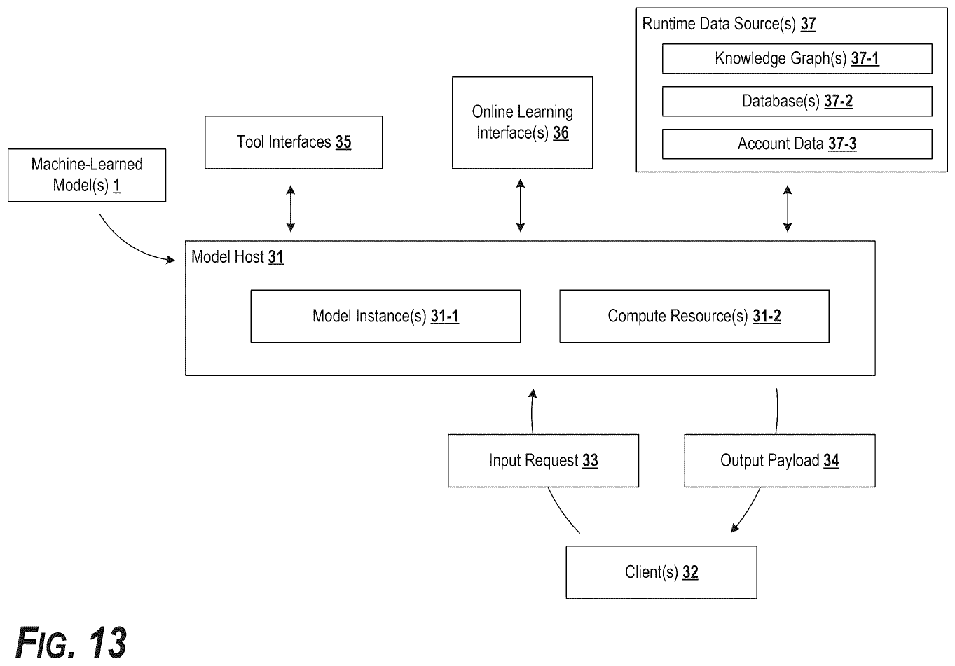

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

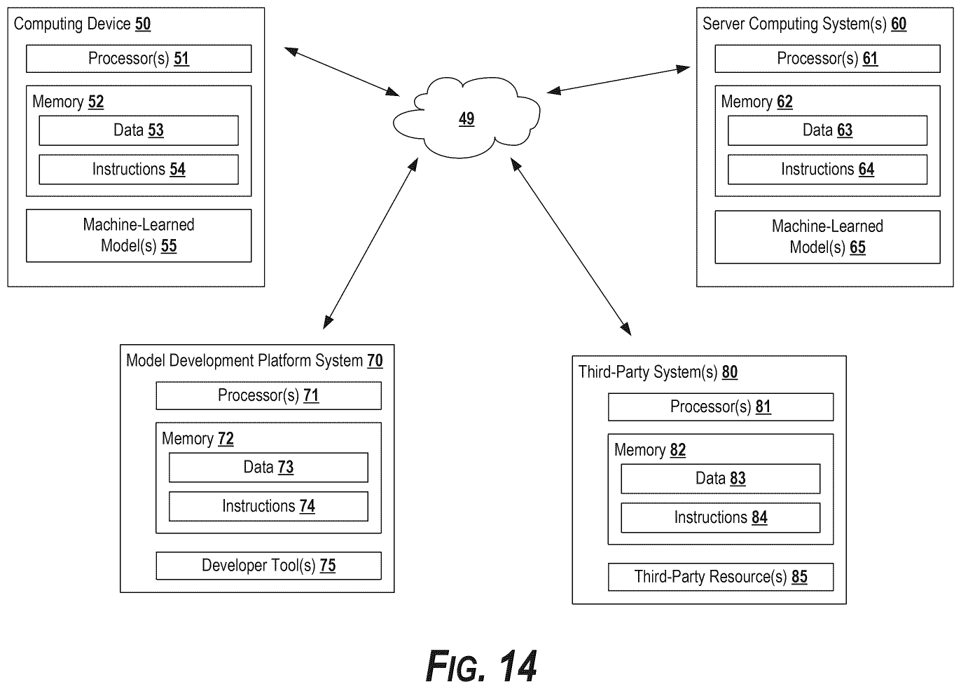

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

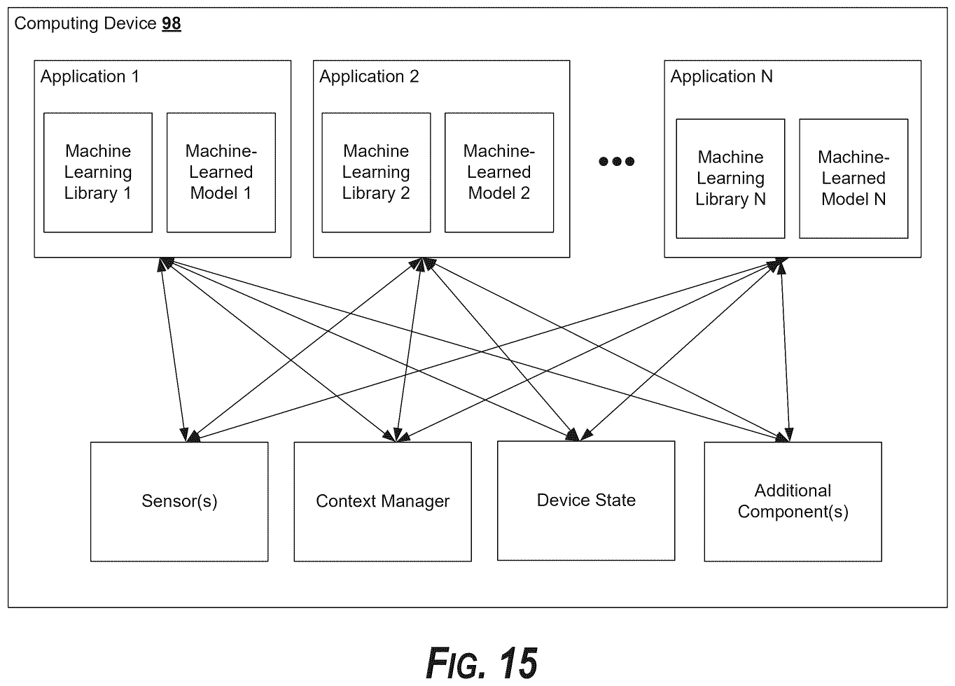

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

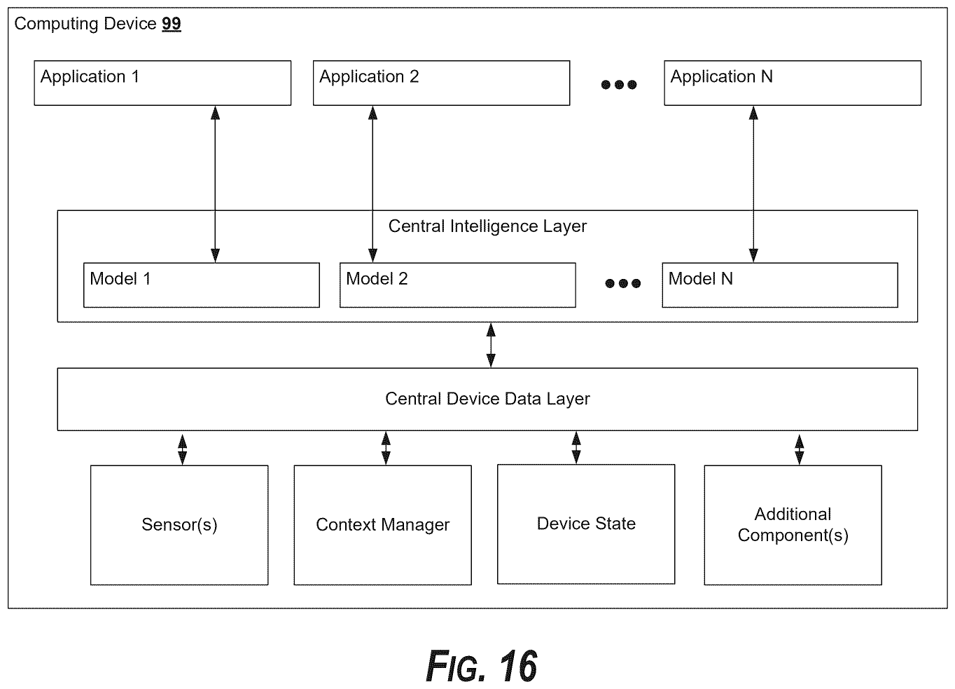

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 13, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 13, the central device data layer can communicate with a number of other components of the computing device, such as, for example, one or more sensors, a context manager, a device state component, or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A system, comprising:
one or more processors; and
one or more non-transitory computer-readable media that collectively store a machine-learned system, the machine-learned system comprising:
a machine-learned image embedding model configured to receive image data and generate one or more image embeddings;
a machine-learned text embedding model configured to receive text data and the one or more image embeddings and generate one or more text embeddings;
a machine-learned cross-modal adapter configured to generate one or more text tokens aligned with one or more image tokens based at least in part on aligning data associated with the one or more text embeddings and the one or more image embeddings; and
a machine-learned sequence processing model configured to receive the one or more text tokens and the one more image tokens and generate an output based at least in part on the one or more text tokens and the one more image tokens.

2. The system of claim 1, further comprising:
one or more text projection layers configured to generate one or more projected text embeddings from the one or more text embeddings; and
one or more image projection layers configured to generate one or more projected image embeddings from the one or more image embeddings;
wherein the machine-learned cross-modal adapter is configured to generate one or more text tokens aligned with one or more image tokens by aligning the one or more projected text embeddings and the one or more projected image embeddings to generate the one or more text tokens and the one or more image tokens.

3. The system of claim 1, wherein:
the machine-learned sequence processing model is configured to receive input including a concatenation of the one or more text tokens, the one or more image tokens, and one or more tokens generated from the text data.

4. The system of claim 1, wherein:
the machine-learned cross-modal adapter includes a down-projection unit and an up-projection unit configured to align the one or more text embeddings and the one or more image embeddings.

5. The system of claim 4, wherein:
the down-projection unit includes a gated linear unit; and
the up-projection unit includes a weight sharing linear layer.

6. The system of claim 4, wherein:
the down-projection unit includes a text down-sampling unit configured to project text features to a smaller dimension and an image-down-sampling unit configured to project image features to the smaller dimension.

7. The system of claim 4, wherein:
the down-projection unit computes a component-wise product of two linear transformations to control information flow and emphasize useful and relevant multimodal feature relationships.

8. The system of claim 4, wherein:
the up-projection unit includes a text up-sampling unit and an image up-sampling unit that share one or more weights; and
the up-projection unit is configured to project text features from a smaller dimension to an input dimension and image features from the smaller dimension to the input dimension.

9. The system of claim 1, wherein:
the machine-learned text embedding model is configured to receive the text data and the one more image embeddings and to generate the one or more text embeddings based at least in part on the one or more image embeddings.

10. The system of claim 1, wherein:
the machine-learned text embedding model includes one or more cross-attention layers.

11. The system of claim 1, wherein:
the machine-learned text embedding model includes a query transformer.

12. A computer-implemented method comprising:
providing, by a computing system comprising one or more computing devices, input text to a text embedding model and input imagery to an image embedding model;
generating, by the computing system using a machine-learned image embedding model, image embeddings based at least in part on the input imagery;
generating, by the computing system using a machine-learned text embedding model, text embeddings based at least in part on the input text and the image embeddings;
generating, by the computing system using a machine-learned cross-modal adapter, one or more text tokens and one or more image tokens based at least in part on the text embeddings and the image embeddings;
providing, by the computing system, an input to a machine-learned sequence processing model, the input including a tokenization of the input text, the one or more text tokens, and the one or more image tokens; and
generating, by the computing system using the machine-learned sequence processing model, an output based at least in part on the tokenization of the input text, the one or more text tokens and the one or image tokens.

13. The computer-implemented method of claim 12, wherein:
the input includes a concatenation of the tokenization of the input text, the one or more text tokens, and the one or more image tokens.

14. The computer-implemented method of claim 12, wherein:
the machine-learned cross-modal adapter includes a down-projection unit and an up-projection unit configured to align the text embeddings and the image embeddings.

15. The computer-implemented method of claim 14, wherein:
the down-projection unit includes a gated linear unit; and
the up-projection unit includes a weight sharing linear layer.

16. A computer-implemented method comprising:
obtaining, by a computing system comprising one or more computing devices, data describing a machine-learned system including a machine-learned text embedding model, a machine-learned image encoding model, a machine-learned cross-modal adapter, and a machine-learned sequence processing model;
obtaining, by the computing system, a first set of training data including image-caption pairs;
training, by the computing system using the first set of training data, the machine-learned system during a first training stage in which the machine-learned cross-modal adapter is trained while parameters of the machine-learned text embedding model, the machine-learned image embedding model, and the machine-learned sequence processing model are frozen;
obtaining, by the computing system, a second set of training data including image-instruction pairs; and
training, by the computing system using the second set of training data, the machine-learned system during a second stage in which the machine-learned cross-modal adapter and the machine-learned text embedding model are trained while parameters of the machine-learned image embedding model and the machine-learned sequence processing model are frozen.

17. The computer-implemented method of claim 16, further comprising:
obtaining, by the computing system, a third set of training data including task-specific training data;
training, by the computing system, the machine-learned system during a third stage in which the machine-learned cross-modal adapter is trained while parameters of the machine-learned image encoding model, the machine-learned sequence processing model, and the machine-learned text embedding model are frozen.

18. The computer-implemented method of claim 17, wherein:
training, by the computing system using the third set of training data, the machine-learned system during the third stage comprises training while parameters of one or more text projections layers and parameters of one or more image projection layers are frozen.

19. The computer-implemented method of claim 16, wherein:
training, by the computing system using the first set of training data, the machine-learned system during the first training stage comprises training one or more text projection layers and training one or more image projection layers.

20. The computer-implemented method of claim 16, wherein:
training, by the computing system using the second set of training data, the machine-learned system during the second stage comprises training one or more text projection layers and training one or more image projection layers.
